(19) United States
(12) Patent Application Publication
(10) Pub. No.: US 2013/0262135 A1
(43) Pub. Date: Oct. 3, 2013

(54) SYSTEM AND METHOD FOR PROVIDER AND PATIENT COMMUNICATIONS

(71) Applicant: CAREWIRE, INC., Excelsior, MN (US)

(72) Inventors: David M. Nichols, Minnetonka, MN (US); Scott Danielson, Minneapolis, MN (US)

(73) Assignee: CareWire, Inc., Excelsior, MN (US)

(21) Appl. No.: 13/803,750

(22) Filed: Mar. 14, 2013

Related U.S. Application Data
(60) Provisional application No. 61/619,746, filed on Apr. 3, 2012.

(51) Int. Cl. G06Q 50/22; G06Q 10/10

(52) U.S. Cl. CPC G06Q 50/22; G06Q 10/10
USPC 705/2

(57) ABSTRACT

Generally discussed herein are systems and methods for facilitating provider-patient communication. In one or more embodiments a method includes storing appointment data indicating a scheduled appointment date for a patient to visit a facility, an appointment time for the patient to visit the medical facility, and an appointment type for the patient visit and correlating the appointment type with a predefined set of messages related to the appointment type. The method can include calculating an arrival time for the patient to arrive at the facility, the arrival time prior to the appointment time and calculated as a function of the appointment type, the appointment time, and the appointment date, and sending, using the one or more processors, a message of the predefined set of messages to a specified recipient at the specified time, the specified time calculated as a function of the appointment type, appointment date, and appointment time.

### BACKGROUND

Medical service providers can provide information to a patient regarding a task the patient should accomplish prior to an appointment. Such information can help the appointment be successful. The instructions can include instructions for a routine physical examination, such as: “do not eat or drink for at least eight hours prior to your appointment”. Some procedures, in order to be successful, can require a patient to accomplish several tasks and honor one or more restrictions. These actions or restrictions can sometimes be required starting a week or more prior to an appointment. Instructions can be mailed out to a patient outlining the tasks they should accomplish and restrictions they should honor. It is up to the patient to remember the actions and restrictions and the timing of them. Sometimes non-compliance may not be discovered until the patient shows up for an appointment, resulting in cancellation of the procedure and possibly a loss of revenue for the medical service provider. A patient can be provided written instructions following an appointment. These written instructions can provide the patient with steps to take to help ensure a speedy and healthy recovery during the weeks following the appointment. For patients who do not follow these instructions, the resulting complications can include calls and inquiries made to the medical service provider and potentially a return to the medical service provider facility for additional treatment.

### SUMMARY

Discussed generally herein are mobile patient engagement solutions which utilize automated patient text messaging prior to or following a scheduled procedure. Such solutions can improve patient compliance with instructions from a doctor prior to the appointment or improve compliance with post-discharge education following the appointment. The outcome of sending these instructions can be an increased efficiency, improved procedure outcomes, and improved patient satisfaction. Messages including plain text and links to web resources can be delivered to patients in timed sequences to help prepare patients for upcoming appointments and procedures and continue to guide them with follow-up reminders and alerts after the procedures.

### BRIEF DESCRIPTION OF THE DRAWINGS

FIG. 1 illustrates a block diagram of an example of a system configured to provide communications between a patient and a provider.

FIG. 2 illustrates a flow diagram of an example of a system configured to provide communications between a patient and a provider.

FIG. 3 and FIG. 4 illustrate an example of a user interface configured to monitor communications between a patient and a provider.

FIG. 5 and FIG. 6 illustrate a flow diagram of an example of a technique for providing communication between a patient and a provider.

FIG. 7 illustrates an example of a computer system.

### DETAILED DESCRIPTION

In the following description, reference is made to the accompanying drawings that form a part hereof, and in which is shown by way of illustration specific embodiments which can be practiced. These embodiments are described in sufficient detail to enable those skilled in the art to practice the disclosure, and it is to be understood that other embodiments can be utilized and that structural, logical and electrical changes can be made without departing from the scope of the present disclosure. The following description of example embodiments is, therefore, not to be taken in a limited sense, and the scope of the present disclosure is defined by the appended claims.

The functions or algorithms described herein can be implemented in software or a combination of software and human implemented procedures in one or more embodiments. The software can consist of computer executable instructions stored on computer readable media such as memory or other types of storage devices. Further, such functions can correspond to modules, which can be software stored on storage devices, hardware, firmware or any combination thereof. Multiple functions can be performed in one or more modules as desired, and the embodiments described are merely examples. The software can be executed on a digital signal processor, ASIC, microprocessor, or other type of processor operating on a computer system, such as a personal computer, server or other computer system.

Definitions:

Caregiver: The entity responsible or authorized to assist in the coordination of care for a Patient (e.g., a parent, friend, sibling, nurse, or other entity that can assist in the coordination).

Customer: The business entity (corporate name) that has contracted to provide the appointment & survey service (e.g., Central Hospital).

Location: The place (location name) where an appointment is scheduled to take place (e.g., Building A).

Department: The department within which an appointment is scheduled to take place (e.g., dermatology, neurosurgery, or the like).

Specialty: The specialty within which an appointment is to take place (e.g., Endoscopy).

Appointment Type: The specific appointment to occur (e.g., Colonoscopy).

Appointment Time: The time a scheduled appointment is to start (e.g., 1:00 PM) as defined by the Customer.

Arrival Time: The time prior to an appointment time when a patient should arrive (e.g., 11:30 AM).

Provider: The individual (doctor, nurse, etc.) performing the primary service associated with the appointment (e.g., Dr. Adams).

Patient: The individual for which the appointment was made (e.g., John Doe).

Customer Dashboard: A password protected, secure website where customers or their employees can view patient status and other patient related data.

A mobile patient engagement solution can use automated recipient (e.g., patient or caregiver) messaging (e.g., text or other content messaging) prior to and following scheduled procedures to improve patient compliance with appointment requirements or procedures. Such messaging can help improve compliance with doctor instruction prior to the appointment and improve compliance with post-discharge education or instruction following the appointment. An advantage of these instructions can include increased efficiency, improved patient procedure outcome, or improved patient satisfaction. Messages including plain text and links to web resources can be delivered to recipients to help prepare a patient for upcoming appointments or procedures and continue to guide the patient with follow-up reminders and alerts. The messages can be delivered in timed sequences to the recipient.

The system can match provider scheduling data to one or more patient communication methodology modules as a function of a patient's appointment type, patient age, appointment department, appointment specialty, or timing considerations, among others. The system can be automated and can be configured to require little or no patient or caregiver login, clinic workflow change, staff training, or recipient-directed marketing. An analytics engine can provide personnel (e.g., a clinic manager, department chief, or system-wide leaders, among others) with real-time information on patient interactivity with the system and the quantity or quality of patient encounters.

The system can enhance revenue and patient satisfaction. The system can increase appointment yield for providers, such as by improving patient preparedness for procedures and providing an early indication on the quality of a patient encounter. The system can guide a patient to better, safer, or more satisfactory healthcare outcomes. The system can provide providers a “turn-key” solution that is ready and operational within days of purchase.

Many outpatient procedures can ask a patient to perform certain tasks and behave in a certain manner in order for the procedure to be properly performed or go smoothly. For example, a task such as “do not eat or drink after midnight the day before the procedure” can be important to the success of the procedure. A patient not following instructions can result in a cancellation of a procedure, which can result in lost revenue. It has been shown that a patient does not follow instructions prior to procedure in about 1 in 15 scheduled outpatient surgeries.

In one or more embodiments, the system can send a text message to a recipient advising them: “Do not eat or drink after midnight tonight.” This simple message can help the patient remember the pre-procedure instructions, which may have been received days or weeks earlier. Some procedures ask the patient to drink certain liquids before the procedure. The pre-procedure instructions can be fairly complicated, and can require certain tasks and behaviors to be performed up to several days prior to the procedure. Multiple messages can be sent. The messages can be tailored by each provider to correspond to the provider's (e.g., hospital, clinic, or the like) preferences.

In an example, a message can be sent to the recipient prior to an appointment advising the patient of the upcoming appointment (e.g., “You have an 11:30 appt. on March 23.”). A message can be sent to inquire whether or not a preparation packet was received (e.g., “Did you receive and read the preparation packet? Y/N”). A message can prompt for a response from the patient or other recipient. These responses can be processed and posted, such as in real-time, to a customer dashboard. If no response is received, or the recipient indicates that they did not receive the instruction, then a phone call, or a further reminder message can be sent by the system or the customer to communicate pre-procedure protocol to the recipient. A further message can then be sent at a desired time before the appointment (e.g., “Please confirm Appt: Y/N”). If “Y” is answered, further messages can ask that the patient arrive at a specified time, bring specified information or documentation, or the like (e.g., “Arrive at 11:30 and park in main lot”, or “Bring a driver license/photo ID and insurance card”). This can be followed by a timely message to remember the pre-procedure protocol (e.g., “No Food or Drink after Midnight.”). Messages can continue after the appointment with reminders about after care procedures or surveys for the patient to complete (e.g., “A Nurse will call you tomorrow”, or “How would you rate your care on a scale of 0-10?”).

One or more embodiments that can include one or more of the advantages discussed are described in detail below with reference to the drawings.

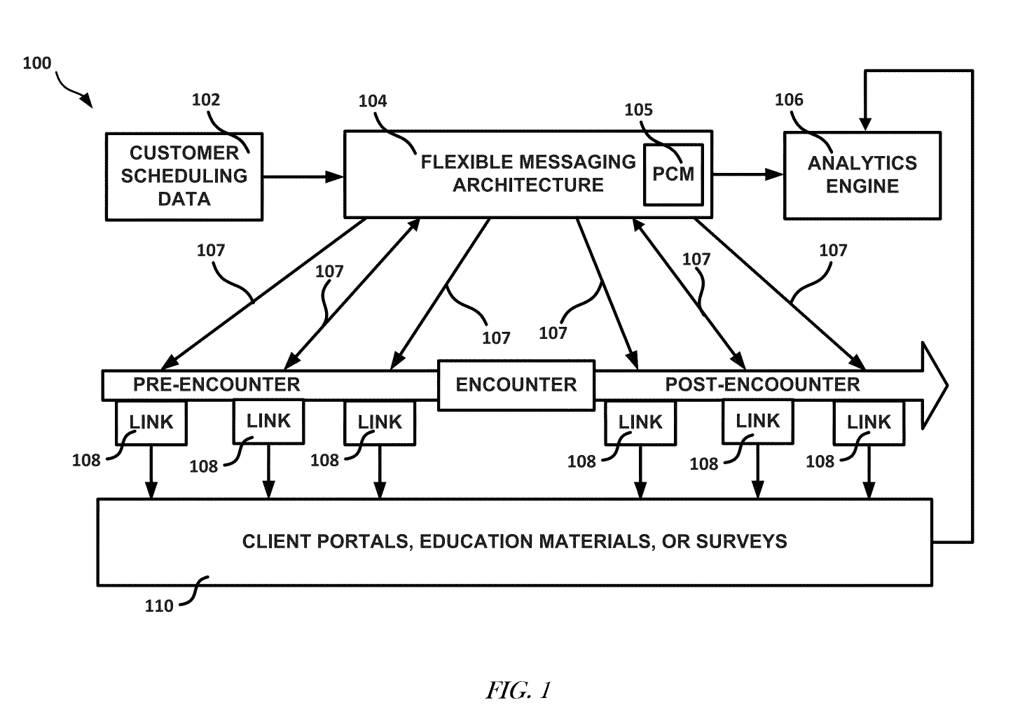

FIG. 1 illustrates an example of a system 100 configured to provide communication between a patient and a provider. Customer schedule data 102 can be received from one or more customers (e.g., hospitals, clinics, or the like). The customer schedule data 102 can be sent to a Flexible Messaging Architecture (FMA) 104. The FMA 104 can match a specific patient schedule to a corresponding Patient Communication Methodology (PCM) module 105 (e.g., a patient who is having a colonoscopy can be correlated with the corresponding colonoscopy communication methodology implemented by the PCM 105).

The FMA 104 can include a PCM module 105 that includes pre-defined sets of communications to be sent to the patient at specific times relative to the appointment time and as a function of an appointment type, patient age, appointment department, appointment specialty, or timing considerations, among others.

The FMA 104 can be configured to send one or more messages or alerts 107 to a recipient (e.g., automatically to a device of a recipient, such as a mobile device, a personal digital assistant (PDA), a mobile phone, laptop, or other device associated with a recipient capable of receiving such messages or alerts). Alternatively, a user (e.g., a customer or provider) of the system 100 can manually cause a message or alert to be sent to a recipient.

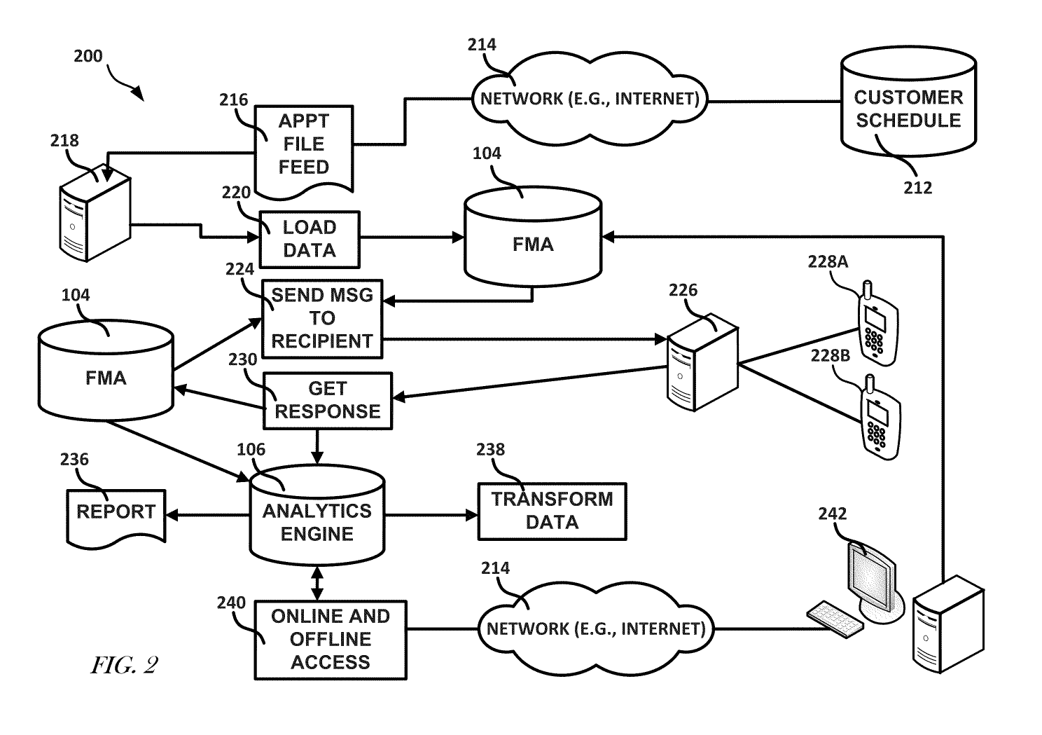

The analytics engine 106 can provide reports 236 (see FIG. 2) (e.g., in real-time) to a customer. The reports 236 can include data indicating the number of patients that are in the system, the quality of service that the patient's report receiving, the number of messages sent to a recipient, the number of appointments that were successfully completed, or the number of appointments that did not occur, among others.

The FMA 104 can receive a response to the message or alert from the recipient (e.g., a device of the recipient). The message or alert 107 can be a reminder for the patient to perform or not perform one or more specified acts. The message or alert can prompt a recipient for a response. The message or alert 107 can be sent pre-encounter (e.g., prior to a scheduled appointment) or post-encounter (e.g., after a scheduled appointment has occurred). The message or alert 107 can include one or more links 108 to a customer or patient portal, educational material, or one or more surveys 110.

Recipient responses to one or more of the client portals, educational materials, or surveys can be sent to the analytics engine 106. The analytics engine 106 can then use this information to update patient information stored therein, update the reports 236, provide information to the customer corresponding to the patient, or the like.

FIG. 2 illustrates an example of a system 200 for providing communication between a recipient and a customer. The system 200 can include a customer scheduling database 212 coupled to a network 214 (e.g., the internet). The customer scheduling database 212 can include patient information including a unique identification (ID), a phone number (e.g., a cell phone number, a voice over internet protocol (VoIP) number, or the like), a specialty of the personnel associated with the appointment, the department of the customer that will host the appointment, the type of appointment, the date and time of the appointment, the provider (e.g., doctor or specialist name), and location of the appointment. The customer scheduling database 212 can include the customer scheduling data 102. Appointment files can be received in batch or in real-time and fed to 216 and uploaded to a server 218. The server 218 can be a secure server, such as a secure server that implements a File Transfer Protocol (FTP).

The data from the server 218 can be loaded 220 and stored on the FMA 104 (e.g., a database of the FMA). The FMA 104 can include patient information as described above and can also include customer information such as a unique ID, location(s), contact numbers, specialties, personnel associated with the customer, or the like. Welcome messages, reminders, surveys, educational material, or other content can be sent to a recipient 224, such as through a web services server 226. The FMA 104 can include the web services server 226. The web services server 226 can be coupled to one or more devices 228A or 228B (e.g., a mobile device or an internet connected device, such as a tablet, PDA, laptop, smartphone, cellular phone, or other device capable of receiving the message or alert) such that text messages and other content messages can be sent to a recipient. Messaging content can be tailored to be device 228A or 228B specific. For example, the web services server 226, or another element of the system 200, can determine the type of device 228A (e.g., whether it is a smartphone capable of receiving multimedia messaging service messages, a cell phone capable of receiving only simple plain text messages, or the like) and tailor the content to be compatible with the device 228A.

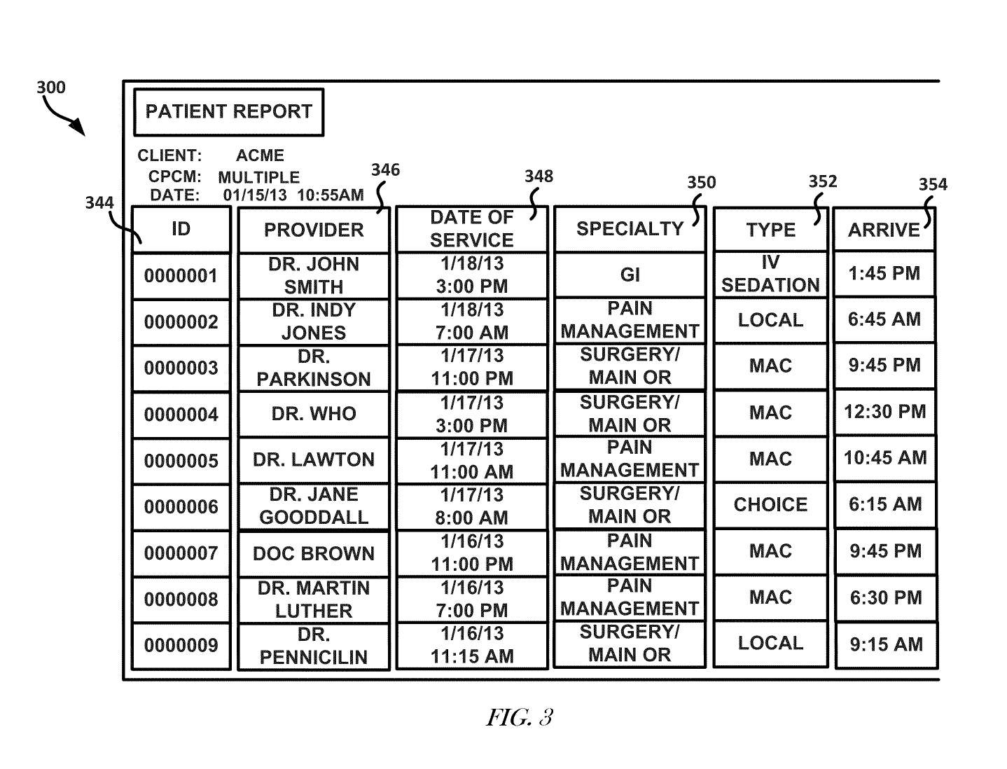

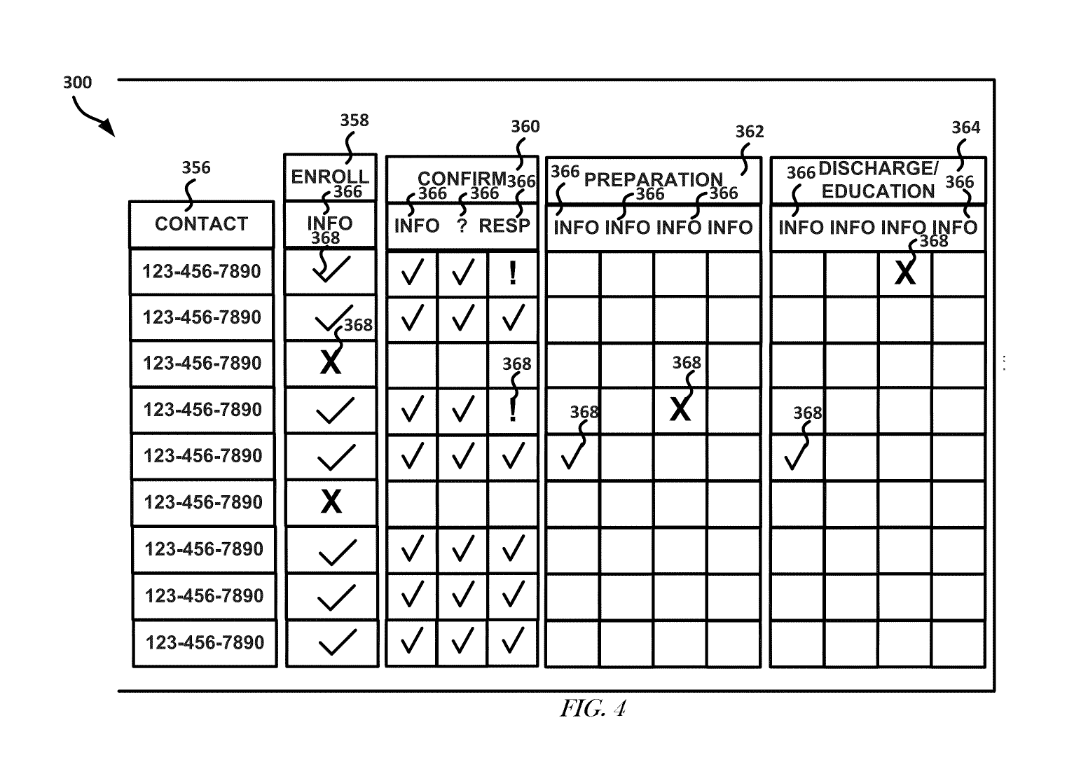

The messages can prompt the patient for a response which can be received 230 and sent to the FMA 104. The FMA 104 can forward the responses to the analytics engine 106. In one or more embodiments, the analytics engine 106 can include the server 218, the PCM 105, the web services server 226, or the FMA 104. The analytics engine 106 can transform data 238. The data can be transformed into dimension or fact tables that can summarize appointments on a variety of levels such as hourly, daily, weekly, monthly, etc. The analytics engine 106 can query the FMA 104 on a number of dimensional attributes, such as type of appointment, time of appointment, location of appointment, patient ID, customer ID, or the like. The analytics engine 106 can produce one or more reports 236, such as reports including information discussed with respect to the customer dashboard of FIG. 3 and FIG. 4.

The report(s) 236 can be uploaded to the server 218 or can be saved to another location in the system 200, such that a customer can have access to the report(s) 236. Online or offline access 240 to the analytics engine 106, FMA 104, or the server 218 can be provided through the network 214 that is coupled to a device 242 of a customer. A customer can cause the analytics engine 106 to produce a report 236 as a function of customer specified criteria, such as dates, times, types of appointments, provider name, patient ID, or the like. The device 242 can be a device capable of connecting to the network 214 and running an application configured to provide access to a customer dashboard or the flexible messaging architecture 104, such as the customer dashboard 300 shown in FIG. 3 and FIG. 4. The device 242 can be substantially the same as the device 228A or 228B.

An authorized user can access the FMA 104 and cause a message or alert to be sent to the device 228A or 228B (e.g., to a recipient). For example, if a provider knows that a patient is particularly forgetful, the provider can access the server 226 and can cause a repeated message or alert to be sent to the recipient. The user can personalize the message to help increase the chances of the patient remembering or to help the chances of the patient carrying out a task the message is trying to get the patient to accomplish. These messages can be sent to the recipient independent of, or in addition to, any scheduled messages to be sent.

In one or more embodiments, the FMA 104 or the web services server 226 can be configured to send messages regarding a single patient to different recipients. For example, consider a child who has two parents that are each available at different times (e.g., one parent works during the day and the other parent works at night, or the parents have joint custody and one parent houses the child some days of the week while the other parent houses the child other days of the week). The FMA 104 can be configured to send a message or alert to the parent that is available such that each parent would receive one or more of the messages as a function of their availability.

In one or more embodiments, sending a message, or receiving a response to a message, can be dependent on a response to a previous message being received or otherwise known. For example, in the case of two recipients (e.g., parents) with different availabilities, a message can indicate to the first parent that the patient should receive medication. The first parent can respond by indicating that the medication was given to the patient. A message can be sent to the second parent indicating that the medication was given to the patient so the second parent knows that the medication was given to the patient.

One or more patient visits to a provider location can be summarized in a report 236 that can appear on a customer dashboard 300. FIG. 3 and FIG. 4 illustrate an example of information that can be displayed in a customer dashboard 300. The information in the customer dashboard 300 can reflect the data stored in the FMA 104, PCM 105, analytics engine 106, or elsewhere in the system 200. The customer dashboard 300 can represent or display information from a report 236. The customer dashboard 300 can display an ID 344 associated with an appointment, customer, or patient. The customer dashboard 300 can display a provider 346 (e.g., doctor, nurse, nurse practitioner, specialist, or the like) associated with the appointment, or the date or time of service 348. The date or time of service 348 can be the customer scheduled time of the appointment (e.g., the time the provider is scheduled to see the patient). The customer dashboard 300 can display a specialty 350 of the provider or the appointment type 352 that is scheduled.

The customer dashboard 300 can display an arrival time 354 (e.g., a time the patient should arrive at the facility where the appointment is scheduled). The arrival time 354 can be automatically calculated by the analytics engine 106. For example, if the date or time of service 348 is 8:00 AM and the appointment type 352 or specialty 350 indicate that the appointment is a colonoscopy, the FMA 104 can calculate (e.g., automatically) how far in advance of the scheduled appointment the patient should arrive at the facility. A message can be sent to the recipient to indicate or remind a patient of the calculated arrival time 354.

As used herein, automatically means without human intervention. For example, the FMA 104 automatically calculating the arrival time 354 means that the FMA 104 uses data stored in the system 200 to determine the arrival time. The data may have been stored with some human input, such as for entering the data for the scheduled date or time of service 348 or for programming how much time to subtract from the scheduled date or time of service 348, but the FMA 104 can perform the operation of calculating such arrival time 354 automatically after such data has been entered.

The customer dashboard 300 can display contact information 356, such as an email address or phone number (as shown in FIG. 4) of the patient. The customer dashboard 300 can display enrollment information 358, confirmation information 360, preparation information 362, or dishcharge education information 364. This information can appear in the form of text, in the form of a grid with symbols in boxes of the grid, or other way of showing the information. In FIG. 4 a check mark means that the task associated with the checkbox was completed. For example a checkmark in the enrollment information 358 related to the “IV Sedation” to be performed by Dr. John Smith, means that the enrollment information was sent to the recipient and that the patient was enrolled. An “X” means that the patient declined the messaging reminder services and an “!” means that the recipient has not yet responded. The “?” can mean questionnaire. For example, a check mark under the “?” in the confirmation information 360 column can mean that a questionnaire was sent to recipient and responses to the questionnaire were returned. The “Resp” can mean a response from the recipient was requested. For example, an “X” under the “Resp” column can mean that a response was either not received from the recipient or that the column is inapplicable in this circumstance, for example.

The headings 366 for the columns can link to information regarding the action that was taken by the system. For example, when a user clicks on the heading a pop-up window or another display can be shown that displays information regarding the action that was taken. Similarly the entries 368 in the grid can be clickable such that in response to a click on an item in the grid, information about the activity or lack of activity taken can be displayed. For example, when a user clicks on the “X” under preparation information 362, a pop-up window can be displayed that describes why preparation information 362 was not sent to a recipient.

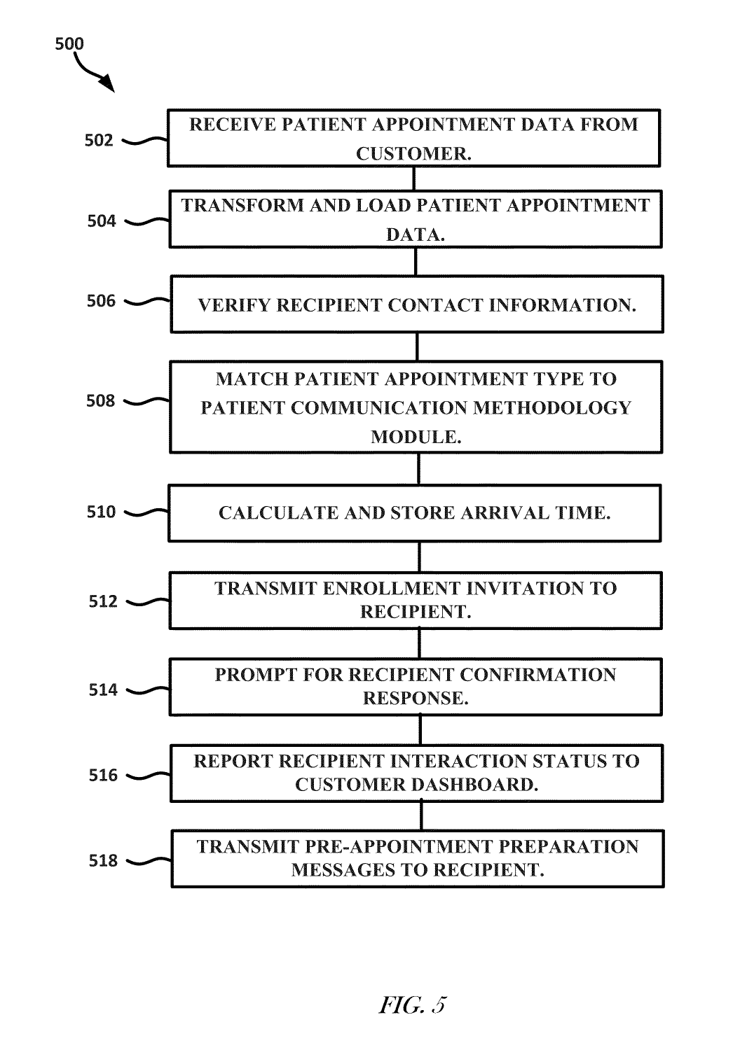

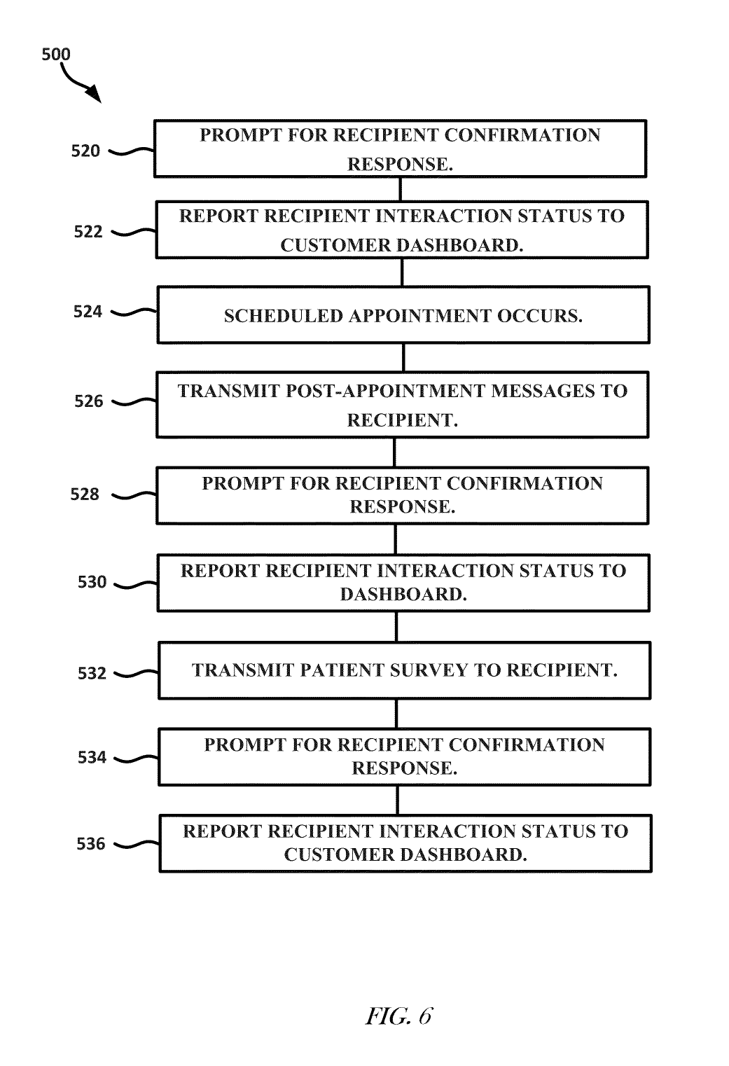

FIG. 5 and FIG. 6 illustrate an example of a flow diagram of a technique 500 for providing communication between a patient and a provider (e.g., a customer). At 502, patient appointment data can be received from a customer, such as over the network 214 or at the server 218. At 504, the patient appointment data can be transformed or loaded into the server 218. The transformation to the data can be to make the data conform to the data already stored in the server 218. The transformation of data can be made to make the data searchable, such as by parsing the data into different fields or key words that the analytics engine 106 can search for. At 506, recipient (e.g., caregiver or patient) contact information can be verified, such as by checking it against a database of patient or caregiver records.

At 508, a patient appointment type 352 (e.g., colonoscopy, surgery, etc.) can be matched to a PCM 105 (e.g., a pre-defined set of communications to be sent to the patient at specific times relative to the appointment time). While the communications to be sent can be pre-defined they can be personalized for the specific patient, such as by including the patient's name, the date of the appointment, or other way of personalizing the communication (e.g., message). At 510, the arrival time 354 can be calculated and stored, such as in the FMA 104. At 512, an enrollment invitation communication can be transmitted to the recipient. At 514, the server 226 can prompt for a recipient confirmation response to the enrollment invitation sent at 512.

At 516, the recipient interaction status (e.g., whether the patient chose to enroll or declined to enroll) can be reported to and updated in the communication dashboard. At 518, pre-appointment preparation messages can be transmitted to the recipient. These messages can include reminders regarding actions to be taken by the patient prior to the appointment. At 520, a prompt for a patient response can be sent to the recipient (e.g., via the recipient's contact number or email). At 522, the recipient interaction status (e.g., whether the recipient confirms that the patient accomplished the preparation actions or not) can be reported to and updated in the communication dashboard 300. At 524, the scheduled appointment can occur.

At 526, post-appointment messages can be transmitted to the recipient. These messages can include one or more links to surveys for the patient to take, links to educational data regarding the procedure done in the appointment, prompts to get the recipient to perform an action, such as actions for rehab, or other information to help the customer get data on the patient's perception of the procedure or to help ensure the patient knows what is expected of them after the procedure. At 528, the recipient can be prompted for a confirmation response. At 530, the recipient interaction status (e.g., whether the patient received the messages or has or is planning on performing actions related to the post-appointment message) can be reported to and updated in the communication dashboard 300. At 532, a survey can be transmitted to the recipient. The survey can be a patient satisfaction survey configured to determine the patient's perception of the level or quality of care received from the provider.

At 534, the recipient can be prompted for a confirmation response. At 536, the recipient interaction status (e.g., whether the patient is willing to fill out the survey or the answers to the prompts in the survey) can be reported to and updated in the communication dashboard 300.

An example of a logical flow of a technique for communicating with a patient before and after a procedure or other appointment is now provided.

| | Example | |
|---|---|---|
| | Timing with | |
| | Respect to | |
| Example Interaction | Appointment | |
| Type | Date | Example Message Delivered to Patient |
| Enrollment | −5 weeks | Central Hospital can send important text msgs to |
| | | help you prepare for your procedure. Text “STOP” |
| | | to stop texts. Text “HELP” for help. Msg & data |
| | | rates can apply. |
| Response Request | −5 weeks | Central Hospital Important Message: Please reply |
| | | now with letter “C” to confirm your Feb 28 |
| | | procedure. Call 555-555-5555 with any questions. |
| Response | Immediate | Central Hospital Confirmation: Thank you for |
| Confirmation | | confirming your Feb 28 procedure. You will |
| | | continue to receive important text messages to help |
| | | you prepare. |
| Reminder | −5 weeks | Central Hospital: Information is needed for your |
| | | Feb 28 appt. Please go to www.abc.com to |
| | | complete your pre-appt history today. |
| Reminder | −5 weeks | Central Hospital Reminder: You must complete a |
| | | MRI prior to your Feb 28 procedure. If you have |
| | | not done so, call 555-555-5555 now to schedule |
| | | your MRI. |
| Response Request | −4 weeks | Central Hospital Reminder: Have you completed |
| | | your MRI? Reply Y/N now. |
| Response | Automated | Central Hospital Confirmation: Thank you for your |
| Confirmation | response | response. You will continue to receive important |
| | | text messages to help you prepare. |
| Reminder | −3 weeks | Central Hospital Reminder: You must have your |
| | | pre-op history/physical completed by an internal/ |
| | | family medicine physician prior to your Feb 28 |
| | | procedure. |
| Response Request | −2 weeks | Central Hospital Reminder: Have you met with an |
| | | internal/family medicine physician and completed |
| | | lab work at hospital? Reply Y/N now. |
| Response | Automated | Central Hospital Confirmation: Thank you for your |
| Confirmation | response | response. You will continue to receive important |
| | | text messages to help you prepare. |
| Reminder | −1 week | Central Hospital Reminder: Your Feb 28 procedure |
| | | is approaching. You will receive specific arrival |
| | | instructions the day prior to your procedure. |
| Reminder | −2 days | Central Hospital: Please arrive at 11:30 AM for |
| | | your Feb 28 appointment. Visit this link for more |
| | | information: www.abc.com |
| Reminder | −1 day | Central Hospital: Please arrive at 11:30 AM for |
| | | your Feb 28 appointment. Bring a responsible |
| | | driver, photo ID and insurance card. |
| Reminder | −1 day | Central Hospital is located at 100 Main Street |
| | | Anytown, OH. Please park in purple lot and enter |
| | | North entrance, or use free valet parking. |
| Reminder | −1 day | Central Hospital: Please arrive tomorrow at 11:30 |
| | | AM for your appointment. This is a fasting |
| | | appointment. DO NOT EAT OR DRINK AFTER |
| | | MIDNIGHT TONIGHT. |

DATE OF APPOINTMENT

| | | |
|---|---|---|
| Response Request | +1 week | Central Hospital Confidential Survey: Overall, how |
| | | would you rate the care you received on Feb 28? |
| | | Please reply with a number from 0 (worst) to 10 |
| | | (best). |
| Response Request | +1 week | Central Hospital Was your rating based on: |
| | | (C)ommunication prior to appt? (I)nformation from |
| | | staff? (S)urgeon's care provided? (please reply with |
| | | a letter) |
| Response | +1 week | Central Hospital Survey Confirmation: Thank you |
| Confirmation | | for your response! It will be used to improve our |
| | | service to patients |
| Reminder | +1 week | Central Hospital hopes your recovery is |
| | | progressing well. Please call us at 555-555-5555 if |
| | | you have any questions or concerns. |
| Response Request | +2 weeks | Central Hospital hopes your recovery is |
| | | progressing well. Is the flexion/bending of your |
| | | knee AT LEAST 90 degrees? Reply Y/N now. |
| Response | Automated | Central Hospital Confirmation: Thank you for your |
| Confirmation | response | response. You will continue to receive important |
| | | text messages to help you prepare. |
| Response Request | +4 weeks | Central Hospital hopes your recovery is |
| | | progressing well. Is the flexion/bending of your |
| | | knee AT LEAST 110 degrees? Reply Y/N now. |
| Response | Automated | Central Hospital Confirmation: Thank you for your |
| Confirmation | response | response. You will continue to receive important |
| | | text messages to help you prepare. |
| PCM Conclusion | +4 weeks | Central Hospital hopes your recovery is |
| | | progressing well. This is the last message you will |
| | | receive regarding you Feb 28 procedure. |

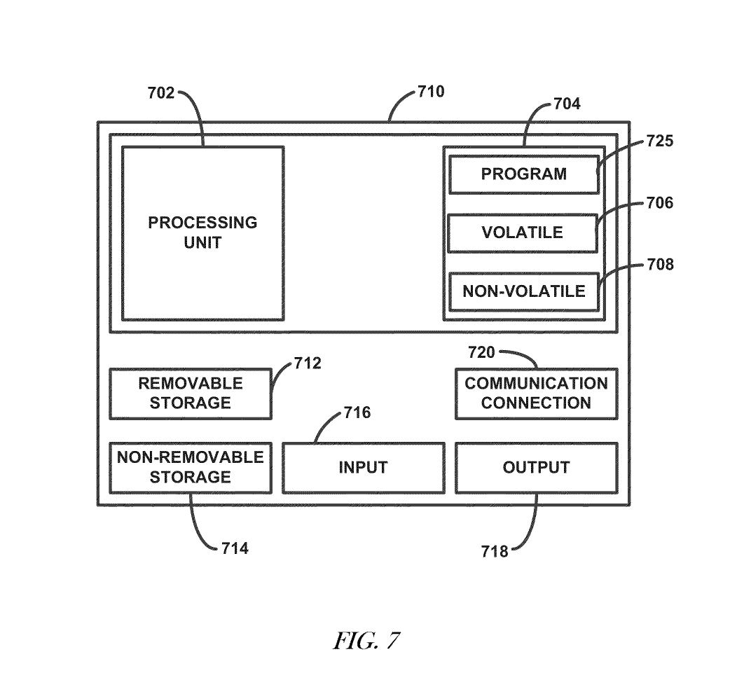

FIG. 7 is a block diagram of a computing device, according to an example embodiment. In one embodiment, multiple such computer systems are utilized in a distributed network to implement multiple components in a transaction based environment. An object-oriented, service-oriented, or other architecture can be used to implement such functions and communicate between the multiple systems and components. One example computing device in the form of a computer 710, can include a processing unit 702, memory 704, removable storage 712, and non-removable storage 714. Memory 704 can include volatile memory 706 and non-volatile memory 708. Computer 710 can include—or have access to a computing environment that includes—a variety of computer-readable media, such as volatile memory 706 and non-volatile memory 708, removable storage 712 and non-removable storage 714. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 710 can include or have access to a computing environment that includes input 716, output 718, and a communication connection 720. The computer can operate in a networked environment using a communication connection to connect to one or more remote computers, such as database servers. The remote computer can include a personal computer (PC), server, router, network PC, a peer device or other common network node, or the like. The communication connection can include a Local Area Network (LAN), a Wide Area Network (WAN) or other networks.

Computer-readable instructions stored on a computer-readable medium are executable by the processing unit 702 of the computer 710. A hard drive, CD-ROM, and RAM are some examples of articles including a non-transitory computer-readable medium. For example, a computer program 725 capable of providing a generic technique to perform access control check for data access and/or for doing an operation on one of the servers in a component object model (COM) based system according to the teachings of the present invention can be included on a CD-ROM and loaded from the CD-ROM to a hard drive. The computer-readable instructions allow computer 710 to provide generic access controls in a COM based computer network system having multiple users and servers.

### ADDITIONAL NOTES AND EXAMPLES

In Example 1 a method includes storing appointment data indicating a scheduled appointment date for a patient to visit a facility, an appointment time for the patient to visit the medical facility, and an appointment type for the patient visit and correlating the appointment type, using one or more processors, with a predefined set of messages related to the appointment type, each message of the predefined set of messages including a specified time to be sent.

In Example 2, the method of Example 1 further includes calculating an arrival time for the patient to arrive at the facility, the arrival time prior to the appointment time and calculated as a function of the appointment type, the appointment time, and the appointment date, and sending, using the one or more processors, a message of the predefined set of messages to a specified recipient at the specified time, the specified time calculated as a function of the appointment type, appointment date, and appointment time.

In Example 3, the method of at least one of Examples 1-2 includes receiving a message from the recipient in response to a request to respond to a sent message.

In Example 4, the method of at least one of Examples 1-3 includes selecting another message from the predefined set of messages to send to the recipient as a function of content of the received message.

In Example 5, the method of at least one of Example 1-4 includes sending a plurality of survey messages to one or more recipients following the appointment date and appointment time.

In Example 6, the method of at least one of Examples 1-5 includes receiving a plurality of messages from the one or more recipients in response to the plurality of survey messages.

In Example 7, the method of at least one of Examples 1-6 includes correlating data from the plurality of received survey messages.

In Example 8, the method of at least one of Examples 1-7 includes providing survey results for the facility as a function of the correlated data to a customer.

In Example 9, at least one message of the set of predefined messages of at least one of Examples 1-8 indicates an action to be taken by the patient prior to the appointment date and the appointment time.

In Example 10, at least one message of the set of predefined messages of at least one of Examples 1-9 indicates an action to be taken by the patient after the appointment.

In Example 11, the method of at least one of Examples 1-10 includes sending a message that is not from the set of predefined messages to the recipient.

In Example 12 a system includes a server configured to receive patient identification data, recipient contact information, and patient appointment data including an appointment type, an appointment date, and an appointment time.

In Example 13, the system of at least one of Examples 1-12 includes a flexible messaging architecture including multiple sets of predefined messages, each set of predefined messages of the multiple sets of predefined messages corresponding to a respective appointment type, each set of predefined messages including a specified time, the specified time indicating when to send a message of the set of predefined messages to the recipient as a function of the recipient contact information, the specified time calculated as a function of the appointment time, appointment date, and appointment type, and wherein the flexible messaging architecture is configured to select and send a message of the set of predefined messages to the recipient at the specified time.

In Example 14, the system of at least one of Examples 1-13 includes an analytics engine configured to receive a message response to the message from the recipient, and compile and transmit statistical information regarding patient satisfaction with a facility to a customer.

In Example 15, the flexible messaging architecture of at least one of Examples 1-14 is configured to send a message that is not from the predefined set of messages to the recipient in response to a user requesting the flexible messaging architecture to send the message.

In Example 16, a message in each set of predefined messages of the multiple sets of predefined messages of at least one of Examples 1-15 includes a survey.

In Example 17, the system of at least one of Examples 1-16 includes a customer dashboard and wherein the analytics engine is configured to receive responses to the survey from a plurality of recipients and compile the responses for presentation in the customer dashboard.

In Example 18, the customer dashboard of at least one of Examples 1-17 includes one or more links that, when activated, present a view of the message corresponding to the link.

In Example 19, a message of the set of predefined messages of at least one of Examples 1-18 includes a link to educational materials about a procedure scheduled to be accomplished during the scheduled appointment.

In Example 20 a computer readable storage device including instructions stored thereon, the instructions, which when executed by a machine, cause the machine to perform operations including storing appointment data indicating a scheduled appointment date for a patient to visit a facility, an appointment time for the patient to visit the medical facility, and an appointment type for the patient visit and correlating the appointment type, using one or more processors, with a predefined set of messages related to the appointment type, each message of the predefined set of messages including a specified time to be sent.

In Example 21, the storage device of at least one of Examples 1-20 includes instructions, which when executed by the machine, cause the machine to perform operations including calculating an arrival time for the patient to arrive at the facility, the arrival time prior to the appointment time and calculated as a function of the appointment type, the appointment time, and the appointment date, and sending, using the one or more processors, a message of the predefined set of messages to a specified recipient at the specified time, the specified time calculated as a function of the appointment type, appointment date, and appointment time.

In Example 22, the storage device of at least one of Examples 1-21 includes instructions, which when executed by the machine, cause the machine to perform operations including receiving a message from the recipient in response to a request to respond to a sent message.

In Example 23, the storage device of at least one of Examples 1-22 includes instructions, which when executed by the machine, cause the machine to perform operations including selecting another message from the predefined set of messages to send to the recipient as a function of content of the received message.

In Example 24, the storage device of at least one of Examples 1-23 includes instructions, which when executed by the machine, cause the machine to perform operations including sending a plurality of survey messages to one or more recipients following the appointment date and appointment time.

In Example 25, the storage device of at least one of Examples 1-24 includes instructions, which when executed by the machine, cause the machine to perform operations including receiving a plurality of messages from the one or more recipients in response to the plurality of survey messages.

In Example 26, the storage device of at least one of Examples 1-25 includes instructions, which when executed by the machine, cause the machine to perform operations including correlating data from the plurality of received survey messages.

In Example 27, the storage device of at least one of Examples 1-26 includes instructions, which when executed by the machine, cause the machine to perform operations including providing survey results for the facility as a function of the correlated data to a customer.

In Example 28, the instructions for sending a message from the predefined set of messages to the recipient at the specified time of at least one of Examples 1-27 include instructions which cause the machine to send a message from the predefined set of messages that indicates an action to be taken by the patient prior to the appointment date and the appointment time.

In Example 29, the storage device of at least one of Examples 1-28 includes instructions, which when executed by the machine, cause the machine to perform operations including sending a message that is not from the set of predefined messages to the recipient.

Some embodiments implement the functions in two or more specific interconnected hardware modules or devices with related control and data signals communicated between and through the modules, or as portions of an application-specific integrated circuit. Thus, the exemplary process flows are applicable to software, firmware, and hardware implementations.

Systems and methods of the present disclosure can be implemented on a mobile device as a mobile application, web-based application, on a desktop computer as a computer application, or a combination thereof. A mobile application can operate on a Smartphone, tablet computer, portable digital assistant (PDA), ruggedized mobile computer, or other mobile device. The mobile device can be connected to the Internet or network via Wi-Fi, Wide Area Network (WAN), cellular connection, WiMax, or any other type of wired or wireless method of networking connection. In some embodiments, a web-based application can be delivered as a software-as-a-service (SaaS) package (e.g. cloud-based embodiments) accessible via a device app, a web browser application, or other suitable application, depending on the particular embodiment.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Although a few embodiments have been described in detail above, other modifications are possible. For example, the logic flows depicted in the figures do not require the particular order shown, or sequential order, to achieve desirable results. Other steps can be provided, or steps can be eliminated, from the described flows, and other components can be added to, or removed from, the described systems. Other embodiments can be within the scope of the following claims.

What is claimed is:

1. A method comprising:
storing appointment data indicating a scheduled appointment date for a patient to visit a facility, an appointment time for the patient to visit the medical facility, and an appointment type for the patient visit;
correlating the appointment type, using one or more processors, with a predefined set of messages related to the appointment type, each message of the predefined set of messages including a specified time to be sent;
calculating an arrival time for the patient to arrive at the facility, the arrival time prior to the appointment time and calculated as a function of the appointment type, the appointment time, and the appointment date; and
sending, using the one or more processors, a message of the predefined set of messages to a specified recipient at the specified time, the specified time calculated as a function of the appointment type, appointment date, and appointment time.

2. The method of claim 1 and further comprising:
receiving a message from the recipient in response to a request to respond to a sent message; and
selecting another message from the predefined set of messages to send to the recipient as a function of content of the received message.

3. The method of claim 1 and further comprising:
sending a plurality of survey messages to one or more recipients following the appointment date and appointment time; and
receiving a plurality of messages from the one or more recipients in response to the plurality of survey messages.

4. The method of claim 3 and further comprising:
correlating data from the plurality of received survey messages; and
providing survey results for the facility as a function of the correlated data to a customer.

5. The method of claim 1 wherein at least one message of the set of predefined messages indicates an action to be taken by the patient prior to the appointment date and the appointment time.

6. The method of claim 1 wherein at least one message of the set of predefined messages indicates an action to be taken by the patient after the appointment.

7. The method of claim 1, further comprising sending a message that is not from the set of predefined messages to the recipient.

8. A system comprising:
a server configured to receive:
patient identification data,
recipient contact information, and
patient appointment data including an appointment type, an appointment date, and an appointment time;
a flexible messaging architecture comprising:
multiple sets of predefined messages, each set of predefined messages of the multiple sets of predefined messages corresponding to a respective appointment type, each set of predefined messages including a specified time, the specified time indicating when to send a message of the set of predefined messages to the recipient as a function of the recipient contact information, the specified time calculated as a function of the appointment time, appointment date, and appointment type; and
wherein the flexible messaging architecture is configured to select and send a message of the set of predefined messages to the recipient at the specified time.

9. The system of claim 8 further comprising an analytics engine configured to receive a message response to the message from the recipient, and compile and transmit statistical information regarding patient satisfaction with a facility to a customer.

10. The system of claim 9 wherein the flexible messaging architecture is configured to send a message that is not from the predefined set of messages to the recipient in response to a provider requesting the flexible messaging architecture to send the message.

11. The system of claim 9 wherein a message in each set of predefined messages of the multiple sets of predefined messages includes a survey.

12. The system of claim 11, further comprising a customer dashboard and wherein the analytics engine is configured to receive responses to the survey from a plurality of recipients and compile the responses for presentation in the customer dashboard.

13. The system of claim 12 wherein the customer dashboard includes one or more links that, when activated, present a view of the message corresponding to the link.

14. The system of claim 8 wherein a message of the set of predefined messages includes a link to educational materials about a procedure scheduled to be accomplished during the scheduled appointment.

15. A computer readable storage device including instructions stored thereon, the instructions, which when executed by a machine, cause the machine to perform operations comprising:
storing appointment data indicating a scheduled appointment date for a patient to visit a facility, an appointment time for the patient to visit the medical facility, and an appointment type for the patient visit;
correlating the appointment type, using one or more processors, with a predefined set of messages related to the appointment type, each message of the predefined set of messages including a specified time to be sent;
calculating an arrival time for the patient to arrive at the facility, the arrival time prior to the appointment time and calculated as a function of the appointment type, the appointment time, and the appointment date; and
sending, using the one or more processors, a message of the predefined set of messages to a specified recipient at the specified time, the specified time calculated as a function of the appointment type, appointment date, and appointment time.

16. The storage device of claim 15, further comprising instructions, which when executed by the machine, cause the machine to perform operations comprising:
receiving a message from the recipient in response to a request to respond to a sent message; and
selecting another message from the predefined set of messages to send to the recipient as a function of content of the received message.

17. The storage device of claim 15, further comprising instructions, which when executed by the machine, cause the machine to perform operations comprising:
sending a plurality of survey messages to one or more recipients following the appointment date and appointment time; and
receiving a plurality of messages from the one or more recipients in response to the plurality of survey messages.

18. The storage device of claim 17, further comprising instructions, which when executed by the machine, cause the machine to perform operations comprising:
correlating data from the plurality of received survey messages; and
providing survey results for the facility as a function of the correlated data to a customer.

19. The storage device of claim 15, wherein the instructions for sending a message from the predefined set of messages to the recipient at the specified time include instructions which cause the machine to send a message from the predefined set of messages that indicates an action to be taken by the patient prior to the appointment date and the appointment time.

20. The storage device of claim 15, instructions, which when executed by the machine, cause the machine to perform operations comprising:
sending a message that is not from the set of predefined messages to the recipient.
